(19) United States
(12) Patent Application Publication
(10) Pub. No.: US 2026/0241211 A1
(43) Pub. Date: Aug. 20, 2026

(54) Identifying Horizontal Lifeline Device

(71) Applicant: BEXUS INDUSTRIES CO., LTD., Taichung City (TW)

(72) Inventor: Yi-Ching Lin, Taichung City (TW)

(21) Appl. No.: 19/373,730

(22) Filed: Oct. 30, 2025

(30) Foreign Application Priority Data
Feb. 19, 2025 (TW) 114106027

(51) Int. Cl. A62B 35/00

(52) U.S. Cl. CPC A62B 35/0056; A62B 35/0093

(57) ABSTRACT

The identifying horizontal lifeline device includes a machine body, a central shaft arranged in the machine body, a drum and a main gear mounted on the central shaft, a cable wound around the drum, a connector can slide axially arranged on the machine body, and a cable reel arranged on the machine body. The connector has a bolt member that can slide axially along a bolt hole at the top end of the machine body and an identification member disposed at the bolt member and outside the bolt hole. The cable reel drives the main gear, causing the drum to reel in the cable and increase the tension applied during horizontal wiring, so as to drive the bolt member to slide axially along the bolt hole to release the identification member, so that the identification member is allowed to rotate to identify that the tension is appropriate.

### BACKGROUND OF THE PRESENT INVENTION

### FIELD OF INVENTION

The present invention relates to the field of horizontal lifelines, and in particular to a technology for determining whether the tension of horizontal wiring is appropriate by determining whether an identification piece can be rotated.

### DESCRIPTION OF RELATED ARTS

Previously, horizontal lifelines, as shown in US Patent 8739929, were used in high-altitude construction sites (such as steel structures or rooftop platforms) where it was not possible to directly provide personnel with safety belts or other safety equipment for hanging so that personnel could still move horizontally and work safely in the site. As shown in FIGS. 1 and 2 of the Patent, the site must first set up a first anchor point and a second anchor point so that the patent can be operated to complete horizontal wiring between the first anchor point and the second anchor point and then provide personnel with safety belts or safety equipment to hang the wiring so that personnel can move and work along the horizontal wiring.

However, the tension of the cable of the horizontal wiring in this patent depends on the personal experience or feel of the staff, and there is no certain judgment standard, which causes operational difficulties.

If the tension is too tight, it can fatigue related components and shorten their service life. If the tension is not tight enough, there's a risk of excessive loosening in response to a person's fall.

Therefore, how to let wiring personnel understand how much tension is appropriate becomes a problem to be solved urgently in the present invention.

### SUMMARY OF THE PRESENT INVENTION

The present invention provides an identifying horizontal lifeline device, which includes:

a machine body having a chamber, a central shaft straddling the chamber transversely, a drum and a main gear mounted on the central shaft, each capable of coaxially rotating, and a cable wound around the drum and capable of extending from the bottom end of the chamber, wherein the machine body further includes a bolt hole extending through the top end of the chamber;

a connector having a bolt member capable of axially sliding along the bolt hole, a spring piece disposed between the bolt member and the bolt hole, and an identification member, a main nut, and a connecting seat disposed at the bolt member and outside the bolt hole, so that the main nut is capable of threading along the bolt member, thereby forcing the identification member to prevent rotation and controlling the spring piece to provide a set pre-pressure to position the bolt member in the bolt hole; and

a cable reel mounted on the machine body drives the main gear, causing the drum to reel in the cable and increase the tension applied during horizontal wiring, overcoming the spring piece when the tension is greater than the set pre-pressure, so as to drive the bolt member to slide axially along the bolt hole to release the identification member, so that the identification member is allowed to rotate to identify that the tension is appropriate.

Therefore, it can be seen that the present invention can operate the cable reel with one hand to gradually increase the tension of the cable during horizontal wiring, and the other hand can continuously apply a slight rotational force to the identification member, and when the identification member can be rotated, the operation of the cable reel can be released, thereby providing the wiring personnel with the understanding that the tension of the cable at this time is appropriate, and its overall operation is quite simple and can effectively improve the traditional trouble of not having a judgment standard, and there is no need for visual inspection, thereby increasing the safety of personnel working at height.

### BRIEF DESCRIPTION OF THE DRAWINGS

FIG. 1 is a perspective view of a preferred embodiment of the present invention.

FIG. 2 is a sectional view of FIG. 1.

FIG. 3 is an exploded view of FIG. 1.

FIG. 4 is a perspective view of a partial assembly of FIG. 3.

FIG. 5 is an exploded view of the connector of the present invention.

FIG. 6 is a sectional view of the assembled connector of the present invention.

FIG. 7 is a rear perspective view of a partial assembly of the present invention.

FIG. 8A is a sectional view of the assembly of FIG. 7.

FIG. 8B is a perspective view of the cable reel disengaged from the main gear of the present invention.

FIG. 9 is a perspective view of the horizontal wiring implementation of the present invention.

FIG. 10 is a partial view of the present invention for identifying the completed adjustment of the horizontal tension of the cable.

### DETAILED DESCRIPTION OF THE PREFERRED EMBODIMENT

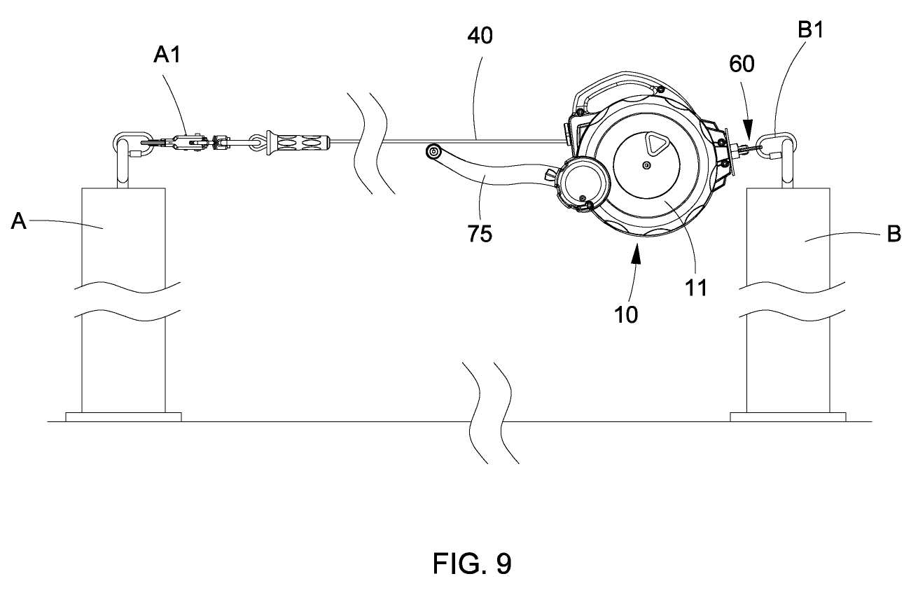

Referring to FIG. 9, the present invention is an identifying horizontal lifeline device that operationally completes a horizontal wiring or retraction between a first anchor point A and a second anchor point B for the suspension of a personnel safety belt or a safety equipment, includes:

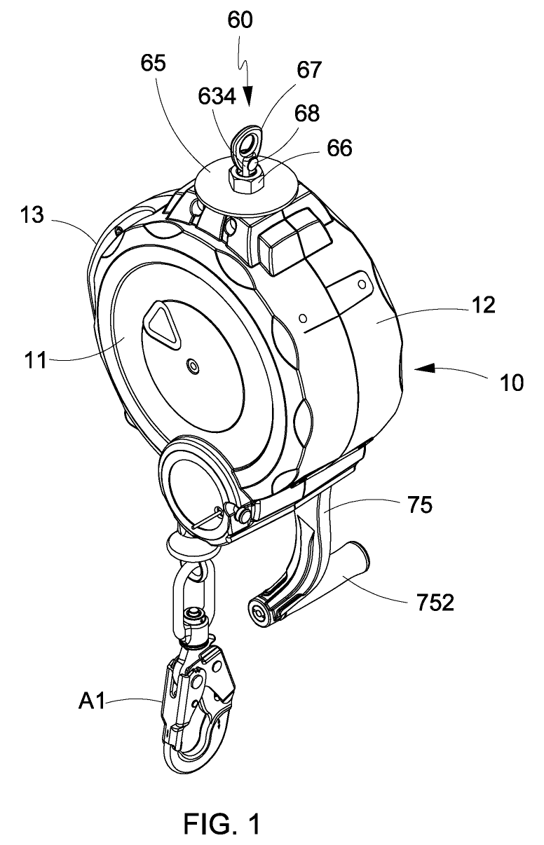

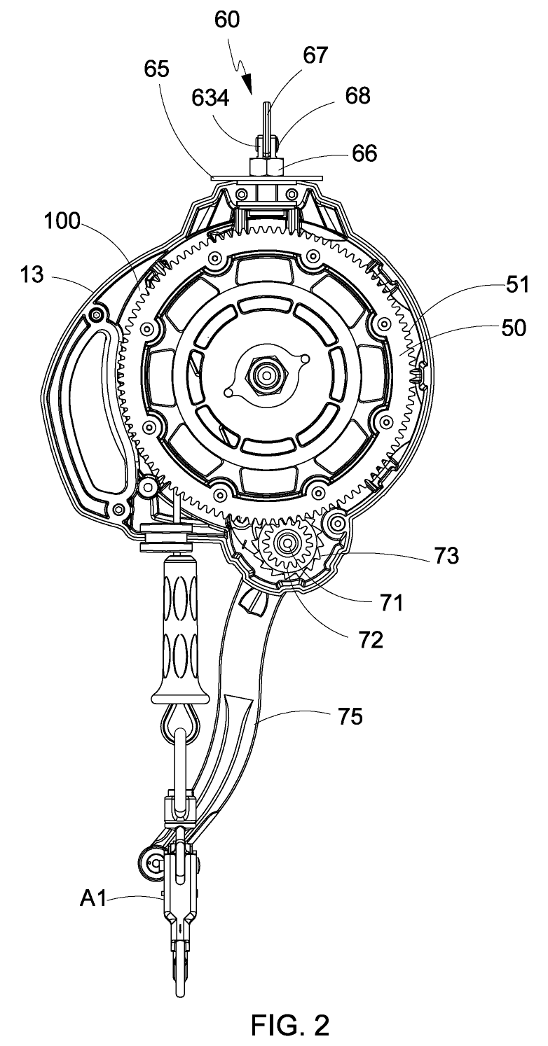

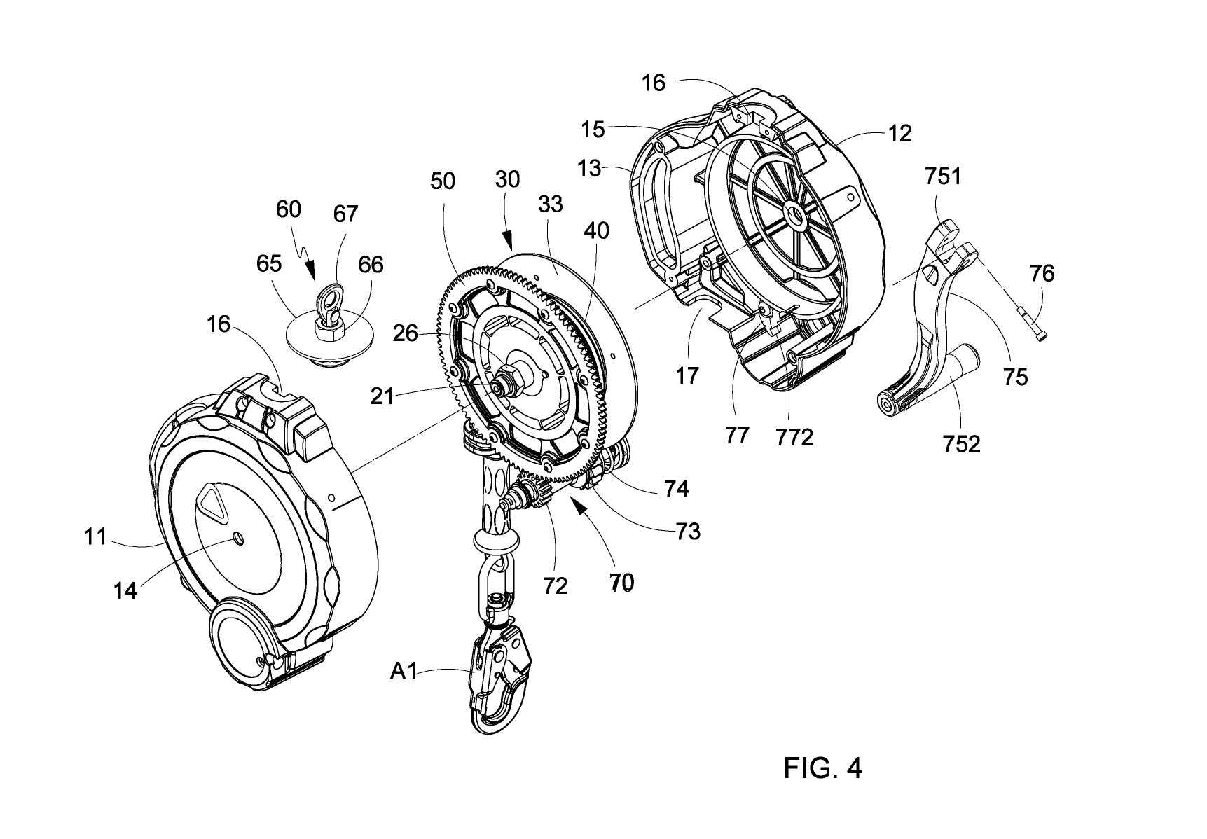

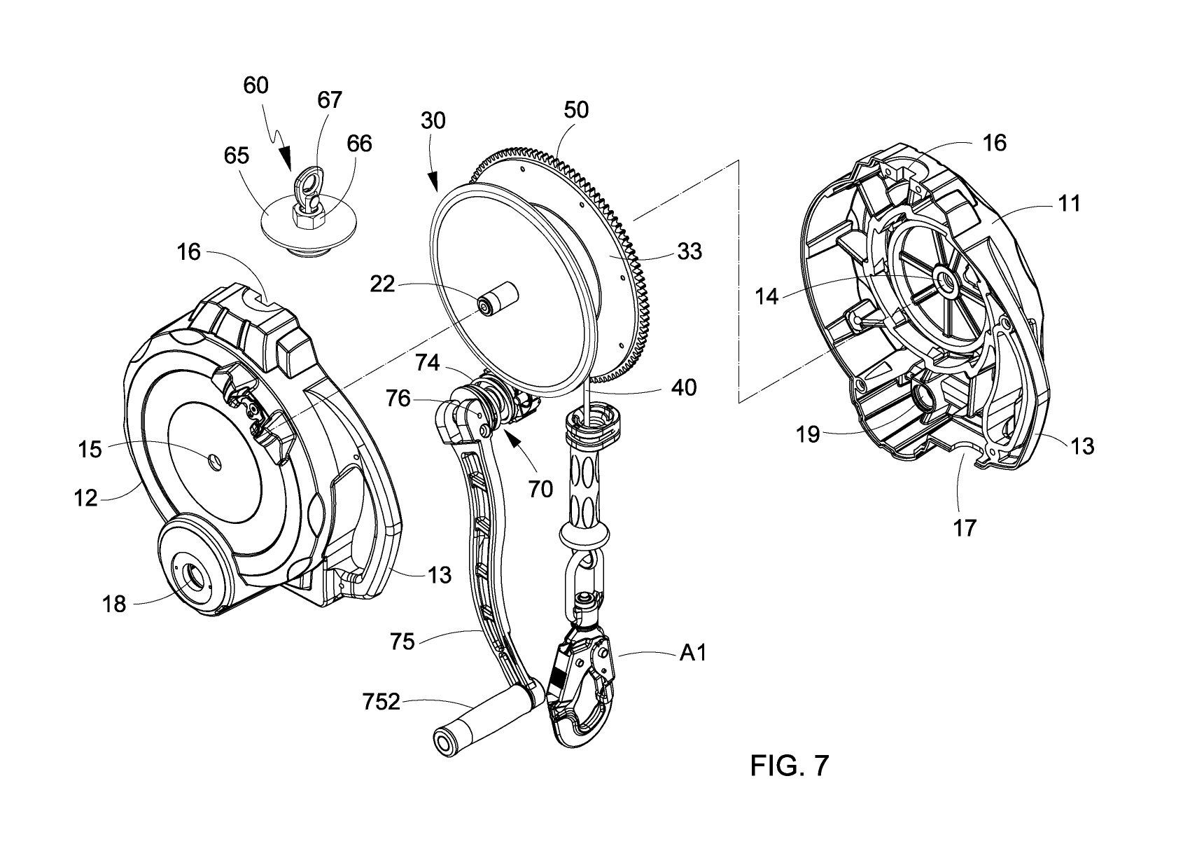

a machine body 10, as shown in FIGS. 1 to 7, including a front shell 11 and a rear shell 12 connected opposite each other and secured together by a plurality of screws to form a hollow chamber 100 inside thereof, and a carrying grip 13 on one side for carrying and layout, wherein the front shell 11 has a front hole 14 extending through the center of the chamber 100, and the rear shell 12 has a rear hole 15 matching the front hole 14, wherein a square-cross-section bolt hole 16 is further longitudinally passed through the front shell 11 and the rear shell 12 at a docked position at the top end of the chamber 100, wherein the bolt hole 16 has an upper concave cavity 161 with a first expanded diameter coaxially connected with the upper end thereof, and a lower concave cavity 162 with a second expanded diameter coaxially connected to the lower end thereof, wherein the upper concave cavity 161 and the lower concave cavity 162 have the same aperture, wherein an outlet 17 is longitudinally passed through the front shell 11 and the rear shell 12 at a joint position at the bottom of the hollow chamber 100, referring to FIG. 7, the rear shell 12 has a pivot hole 18 passing through the front and rear of the hollow chamber 100 at the bottom edge thereof, and the front shell 11 has a rotary hole 19 matching the pivot hole 18;

a central shaft 20 straddling the hollow chamber 100 transversely, the front end of which is mounted in the front hole 14 through a front bearing 21, and the rear end of which is mounted in the rear hole 15 through a rear bearing 22, for enabling the central shaft 20 to rotate in response to horizontal wiring or retraction, wherein the central shaft 20 has a projecting shoulder 23 and an external thread 24 disposed thereon, and has a key block 25 mounted between the projecting shoulder 23 and the external thread 24, wherein a nut 26 is screwed onto the external thread 24;

a drum 30 having a shaft hole 31 arranged at a center thereof for the central shaft 20 to pass through, wherein the rear end of the drum 30 abuts against the projecting shoulder 23, and the nut 26 is screwed along the external thread 24 to clamp the drum 30 to the projecting shoulder 23, wherein the shaft hole 31 has a keyway 32 recessed therein for the key block 25 to engage, allowing the central shaft 20 and the drum 30 to rotate coaxially as a whole, wherein the drum 30 has an annular concave limiting space 33 formed on an outer periphery thereof, wherein the drum 30 has a washer 34 installed between the rear end thereof and the projecting shoulder 23;

a cable 40, preferably up to 60 feet in length, having one end fixed within the limiting space 33, and the other end extending out of the machine body 10 through the outlet 17 to provide installation for a first fastener A1, wherein the cable 40 is mostly looped around the limiting space 33 of the drum 30,so that when the first fastener A1 is fastened to the first anchor point A as shown in FIG. 9, and a person carries the machine body 10 to move toward the second anchor point B, the cable 40 pulls the drum 30 and central shaft 20 to rotate, sequentially pulling out the cable 40;

a ring-shaped main gear 50 having a plurality of teeth 51 arranged on an outer circumference and is coaxially locked to the front periphery of the drum 30 via a plurality of bolts 52, so that the main gear 50 and the drum 30 can rotate coaxially as a whole;

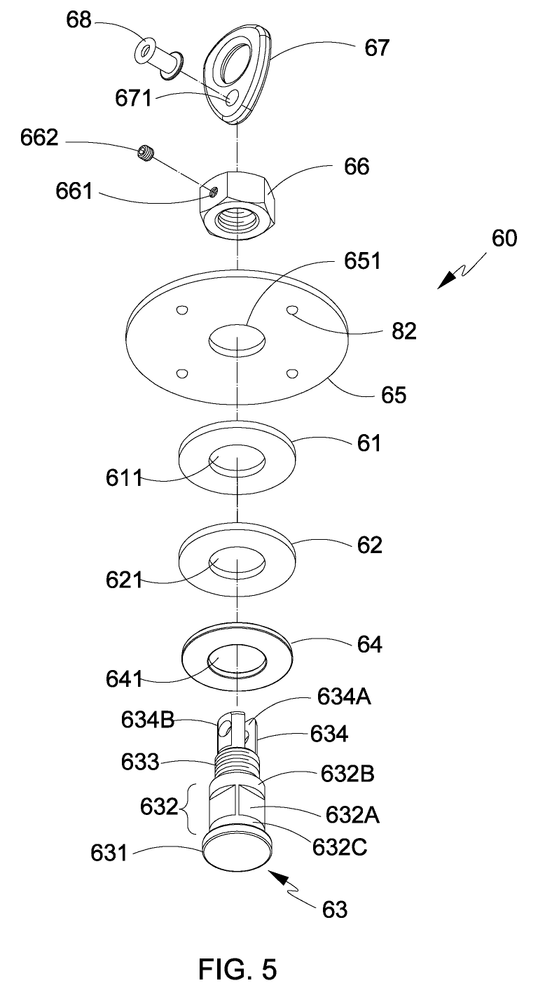

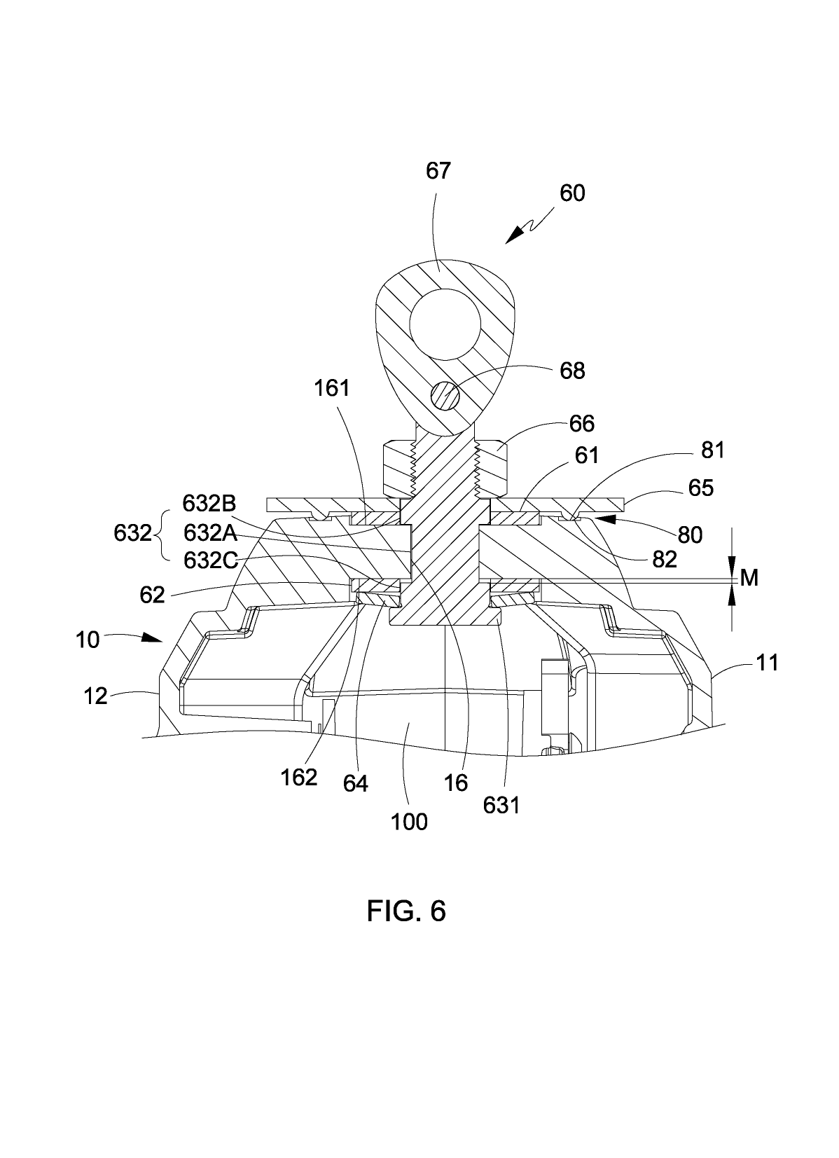

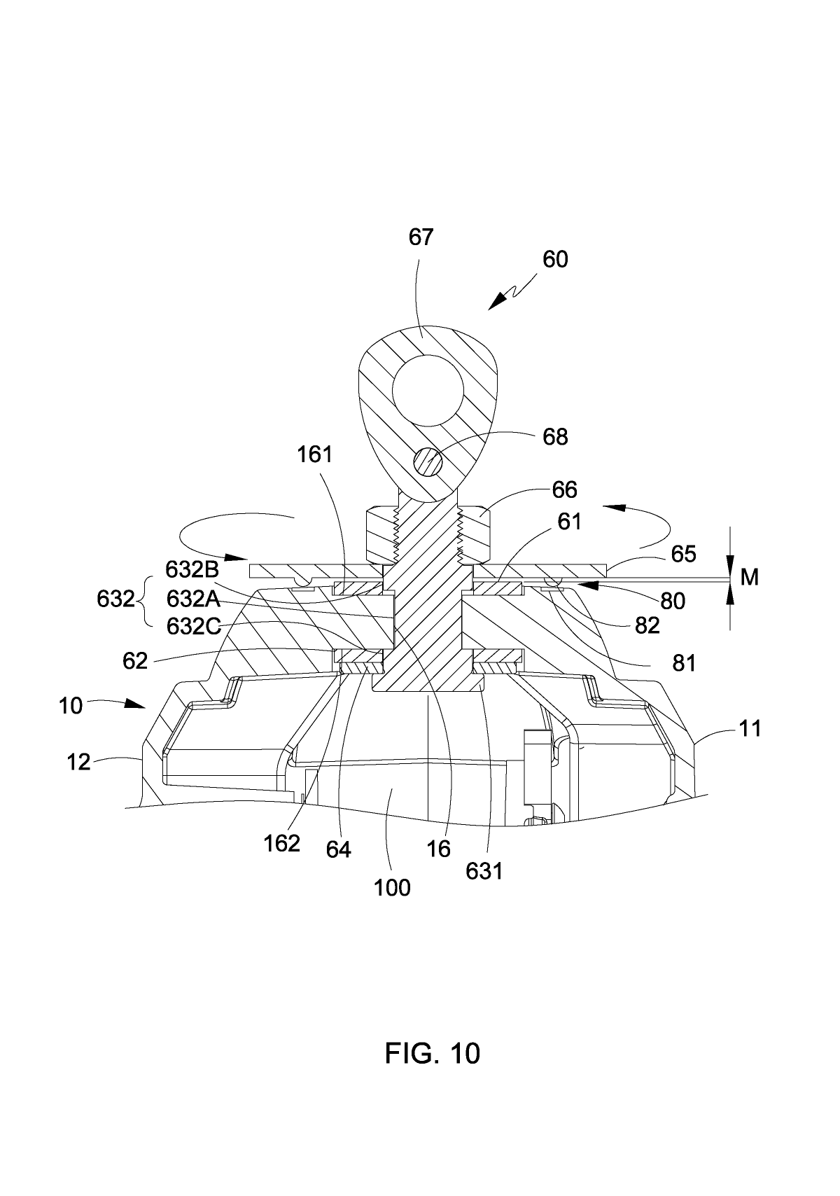

a bolt hole 60 mounted on the bolt hole 16, providing an external connection for the second fastener B1 in FIG. 9, thereby securing the machine body 10 to the second anchor point B, referring to FIGS. 5 and 6, the connector 60 includes a bolt member 63 capable of sliding axially along the bolt hole 16, a spring piece 64 concealed below the bolt hole 16, an identification member 65 exposed externally above the bolt hole 16, a main nut 66 located above the identification member 65, and a connecting seat 67 located above the main nut 66, as shown in the figure, an upper pad 61 is configured on the upper concave cavity 161, wherein the upper pad 61 has an upper hole 611 coaxially arranged therewith that communicates with the bolt hole 16, wherein the diameter of the upper hole 611 is larger than that of the bolt hole 16, wherein the top surface of the upper pad 61 protrudes from the top of the machine body 10 and abuts the bottom surface of the identification member 65, wherein a lower pad 62 is configured on the lower concave cavity 162, wherein the lower pad 62 is symmetrical in shape to the upper pad 61 and has a lower hole 621 connecting to the bolt hole 16, wherein the bolt member 63 has a cap head 631, a shaft section 632, a threaded section 633, and a pivot section 634, which are coaxially defined with decreasing outer diameters from bottom to top, wherein the cap head 631 is held in the chamber 100 and abuts against the bottom surface of the spring piece 64, wherein the spring piece 64 shown in the figure is a disc spring, but other types of springs (such as laminated leaf springs, coil springs, ring springs, etc.) can be used as equivalent springs, wherein the spring piece 64 is clamped between the cap head 631 and the bottom surface of the lower pad 62, preventing direct pressure and wear on the lower concave cavity 162, wherein the spring piece 64 has a spring hole 641 for the shaft section 632 to pass through, wherein the outer diameter of the shaft section 632 is matched with the upper hole 611 and the lower hole 621, and then milled and processed, and the middle section is necked down to form a square middle bolt 632A that matches the square bolt hole 16, wherein the shaft section 632 is defined in order from top to bottom as the upper bolt 632B, the middle bolt 632A, and the lower bolt 632C, so that the upper bolt 632B penetrates the upper hole 611 and protrudes the top of the upper hole 611, and the lower bolt 632C is through the lower hole 621 and the spring hole 641, ensuring that the spring piece 64 is stably arranged between the bolt member 63 and the bolt hole 16, wherein the assembly requires the modular configuration of the lower pad 62, bolt member 63, and spring piece 64 first, followed by clamping the middle bolt 632A through the bolt hole 16 formed in half on the front shell 11 and the rear shell 12, which allows the middle bolt 632A to be installed in the bolt hole 16, thus ensuring practicality without a doubt, wherein the bolt hole 16 and the middle bolt 632A are configured to restrict the rotation of the bolt member 63, thereby facilitating stable adjustment of the locking stress of the main nut 66 using a torque wrench, and the bolt member 63 is prevented from dislodging from the lower end or upper end of the bolt hole 16, as shown in FIGS. 6 and 10, the present invention further controls the middle bolt 632A to have a margin M for axial movement along the bolt hole 16, wherein the identification member 65 is superimposed on the top surface of the upper pad 61 and has a rotation hole 651 capable of rotating around the upper bolt 632B, wherein the main nut 66 is mounted on the threaded section 633, as shown in FIG. 6, when the main nut 66 is screwed along the threaded section 633 of the bolt member 63 using a torque wrench to tighten the identification member 65 to the point of being unable to rotate, and the spring piece 64 is further controlled to provide a set pre-pressure to position the bolt member 63 in the bolt hole 16, in order to prevent the main nut 66 from loosening at the set pre-pressure, the main nut 66 has a threaded hole 661 is radially penetrated therethrough for a set screw 662 to lock with the threaded section 633, wherein the pivot section 634 has a slot 634A cut downward from the top for the connecting seat 67 to be inserted into, and a rivet hole 634B radially penetrating therethrough, wherein the rivet hole 634B is used for installing a rivet 68, and is used for riveting a connecting hole 671 pre-arranged at the bottom edge of the connecting seat 67, so that the connecting seat 67 capable of swing with the rivet 68 as a fulcrum, so that the second fastener B1 can install the connecting seat 67 to the second anchor point B in order to complete the horizontal wiring between the first anchor point A and the second anchor point B; and

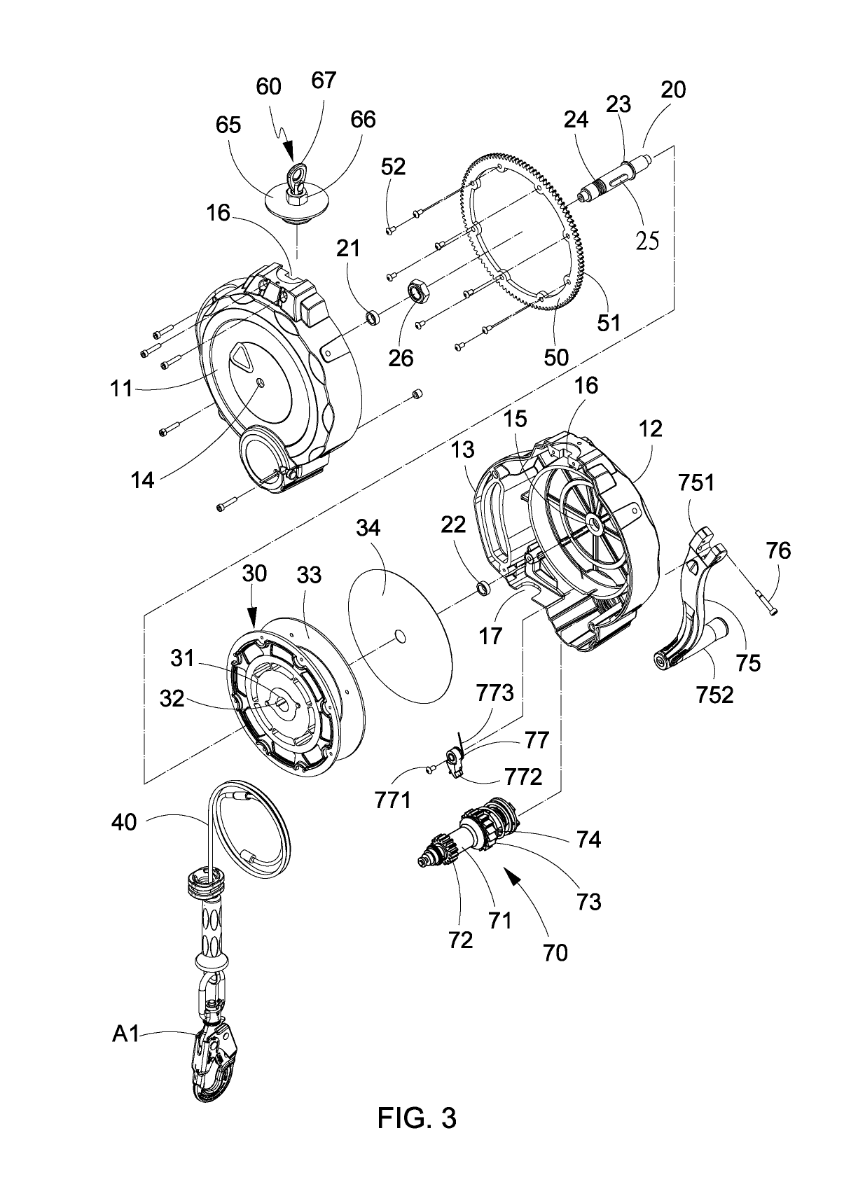

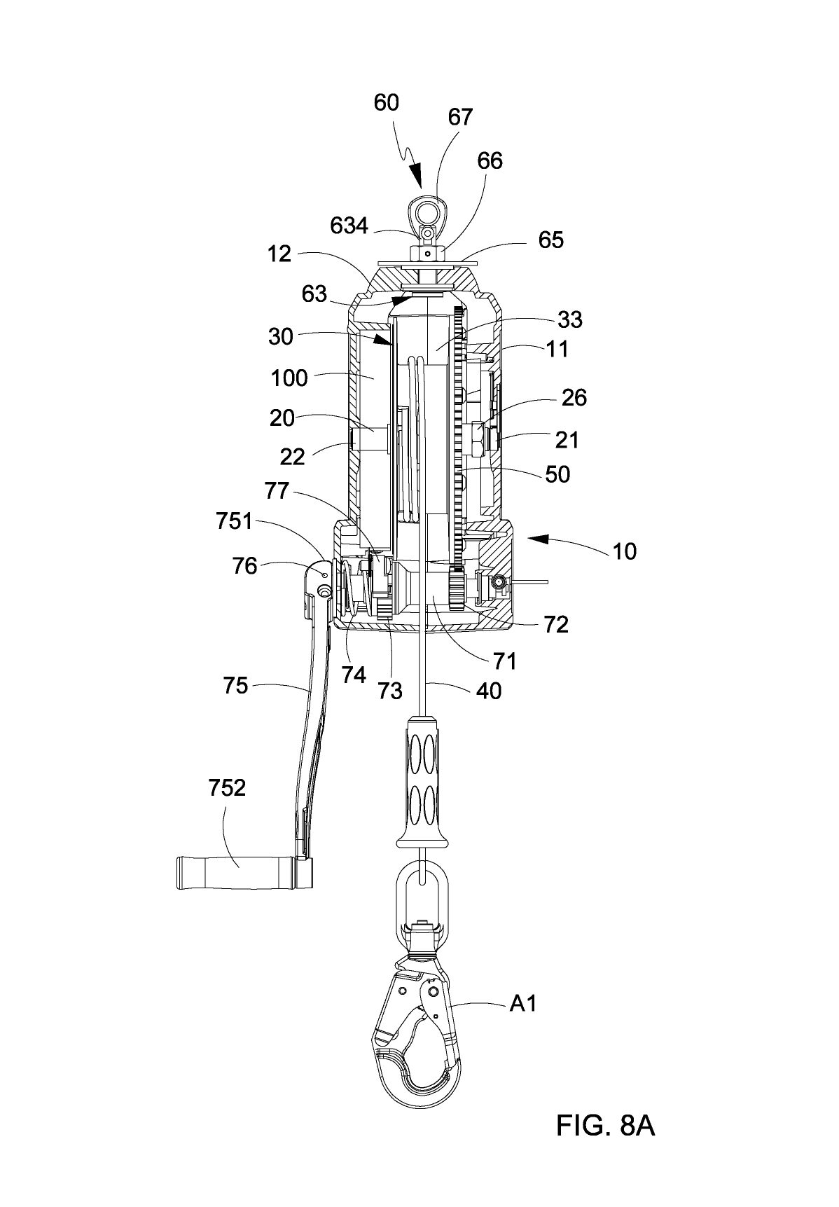

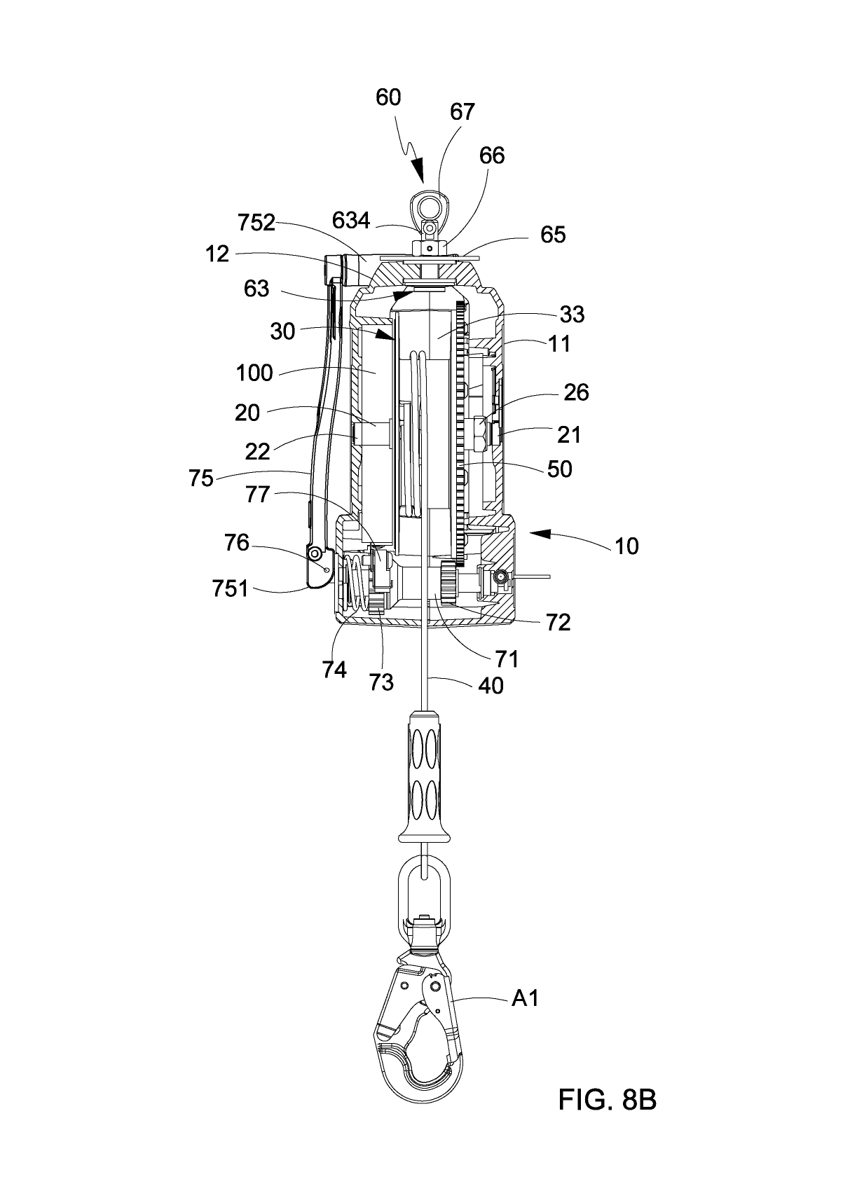

a cable reel 70 mounted on the machine body 10, as shown in conjunction with FIGS. 7, 8A, and 8B, includes a support shaft 71, a sub-gear 72, a ratchet 73, a spring 74, a handle 75, and a ratchet block 77, wherein the support shaft 71 is coupled with the pivot hole 18 and the rotary hole 19 and is provided with the sub-gear 72 and the ratchet 73, and the support shaft 71 is axially movable along the pivot hole 18 and the rotary hole 19, enabling the sub-gear 72 to switch between a first position engaged with the main gear 50, and a second position disengaged from the main gear 50, wherein the spring 74 abuts between the rear end of the ratchet 73 and the rear shell 12, so that the sub-gear 72 has the momentum to position towards the first position at any time, thereby maintaining the sub-gear 72 in the meshing position with the main gear 50, wherein the rear end of the support shaft 71 protrudes from the pivot hole 18 and is radially penetrated by a shaft rod 76 for coupling to a handle 75 that can be unfolded or retracted, when the handle 75 is unfolded, it drives the support shaft 71 to rotate in the reverse direction as shown in FIG. 8A , thereby gradually increasing the tension of the cable 40 of the present invention applied to the horizontal wiring, wherein a cam 751 protrudes from the portion where the handle 75 is coupled to the shaft rod 76, and a crank 752 is vertically coupled to the free end of the handle 75, as shown in FIG. 8B, when the handle 75 is rotated upward with the shaft rod 76 as a fulcrum and retracted onto the back of the rear shell 12, the cam 751 abuts against the rear end of the pivot hole 18, causing the support shaft 71 to slide axially rearward, thereby overcoming the elastic force of the spring 74 and placing the sub-gear 72 in the second position, which is separated from the main gear 50, to prevent the cable reel 70 from interfering with the outward pulling and deployed wiring of the cable 40 surrounding drum 30, referring to FIG. 3, one end of the ratchet block 77 is pivotally connected with the rear shell 12 via a pin 771, and the other end of the ratchet block 77 is provided with a pawl 772, and a torsion spring 773 is installed, wherein one end of the torsion spring 773 abuts the rear shell 12, and the other end drives the ratchet block 77, ensuring that the pawl 772 remains engaged with the ratchet 73 regardless of whether the position is the first position or the second position, so that when the sub-gear 72 is in the first position, the sub-gear 72 cannot rotate in the forward direction to pull out the cable 40, but can only rotate in the reverse direction to drive the main gear 50, causing the drum 30 to reel in the cable 40 and increase the tension, wherein when the tension is greater than the pre-pressure by the setting, the spring piece 64 can be overcome, as shown in FIG. 10, the spring piece 64 can be further compressed to deform to promote the bolt member 63 to have sufficient margin M to move up along the bolt hole 16 to release the identification member 65, so that the identification member 65 can be rotated by the personnel to identify the tension as appropriate, at this time it means that the tension of the cable 40 has met the original design requirements, and the personnel are reminded that there is no need to continue to rotate the handle 75, wherein when the tension of the cable 40 reaches a certain level, the identification member 65 can be recognized by the rotation of the person, which is the present invention.

In the initial state of the present invention, as shown in FIG. 8B, the handle 75 is retracted, disabling the cable reel 70 from driving the main gear 50. When horizontal wiring is to be performed, the first fastener A1 is operated to fasten and conn ect the first anchor point A as shown in FIG. 9 to secure the other end of the cable 40. Subsequently, the operator lifts the machine body 10 to move in the direction of the second anchor point B to sequentially pull out the cable 40 until the connector 60 can be fastened with the second anchor point B by the second fastener B1. Then, as shown in FIG. 8A, the operating handle 75 is unfolded, and the operator can operate the drum 30 to reel in the cable 40 through the handle 75 with one hand to increase the tension of the cable 40 during horizontal wiring. As for the operator, the other hand slightly applies a rotating force to the identification member 65. When the identification member 65 can be rotated as shown in FIG. 10, the wiring operator can determine that the tension is appropriate and stop operating the cable reel 70. The overall implementation is very simple, greatly eliminating the problem of the traditional lack of judgment standards and eliminates the need for visual inspection. This effectively increases the safety of personnel working at height. When the operator completes the work at height and wishes to reel in the cable, he or she simply retracts the handle 75 as shown in FIG. 8B to release the tension and loosen the second fastener B1. Next, the handle 75 is unfolded as shown in FIG. 8A, causing the handle 75 to drive the drum 30 to reel in the cable 40 and simultaneously move toward the first anchor point A. After the cable 40 is completely reeled in, the handle 75 is retracted as shown in FIG. 8B, and the first fastener A1 is released from the first anchor point A. This completes the entire operation mode.

Refer to FIGS. 5 and 6. In order to further remind that the tension is appropriate, the present invention may further include a reminder structure 80 provided between the identification member 65 and the machine body 10. The machine body 10 has a plurality of female nodes 81 recessed with the bolt hole 16 as the center, and the identification member 65 has a plurality of male nodes 82 protruding for matching the plurality of female nodes 81. When the main nut 66 tightens the identification member 65 and cannot rotate, the female nodes 81 and the male nodes 82 are mutually engaged. When the aforementioned tension is appropriate and a rotational force is applied to the identification member 65 by the operator, the male nodes 82 can enter and exit the female nodes 81, thereby emitting a shaking feeling and sound to further remind the user to stop operating the cable reel 70.

In summary, the overall structural features of the present invention can be said to be unprecedented in the conventional structure, and it is a very outstanding and excellent design, and there are no similar inventions or publications in similar products, so it meets the application requirements of the invention patent, and the application is filed according to law. However, the above is only one of the better embodiments of the present invention, and it cannot be used to limit the scope of the exploitation of the present invention, that is, all equivalent changes and modifications made according to the patent scope of the present invention belong to the scope of the present invention.

What is claimed is:

1. An identifying horizontal lifeline device, comprising:
a machine body having a chamber, a central shaft straddling the chamber transversely, a drum and a main gear mounted on the central shaft, each capable of coaxially rotating, and a cable wound around the drum and capable of extending from the bottom end of the chamber, wherein the machine body further comprises a bolt hole extending through the top end of the chamber;
a connector having a bolt member capable of axially sliding along the bolt hole, a spring piece disposed between the bolt member and the bolt hole, and an identification member, a main nut, and a connecting seat disposed at the bolt member and outside the bolt hole, so that the main nut is capable of threading along the bolt member, thereby forcing the identification member to prevent rotation and controlling the spring piece to provide a set pre-pressure to position the bolt member in the bolt hole; and
a cable reel mounted on the machine body drives the main gear, causing the drum to reel in the cable and increase the tension applied during horizontal wiring, overcoming the spring piece when the tension is greater than the set pre-pressure, so as to drive the bolt member to slide axially along the bolt hole to release the identification member, so that the identification member is allowed to rotate to identify that the tension is appropriate.

2. The identifying horizontal lifeline device, as recited in claim 1, wherein the bolt member is installed in the bolt hole in a non-rotatable manner, the spring piece is located below the bolt hole, the identification member is located outside above the bolt hole, the main nut is located above the identification member, and the connecting seat is located above the main nut, wherein the bolt member is passed through the spring piece and the identification member in sequence from bottom to top, and then the main nut and the connecting seat are installed, and the bolt member has a cap head capable of urging the bottom surface of the spring piece and is arranged thereof.

3. The identifying horizontal lifeline device, as recited in claim 2, wherein the machine body comprises a front shell and a rear shell connected oppositely, the front end of the central shaft being mounted on the front shell and the rear end of the central shaft being mounted on the rear shell, wherein the front shell and the rear shell are provided with the bolt hole at a top docked position of the chamber, and an outlet is provided at a bottom docked position of the chamber, wherein one end of the cable is fixed to the drum, and the other end of the cable is extended out of the machine body through the outlet,
wherein the bolt member has the cap head, a shaft section, a threaded section, and a pivot section, which are coaxially defined from bottom to top, wherein the cap head is retained in the chamber, the spring piece has a spring hole for the shaft section to pass through, and the identification member has a rotation hole capable of rotating around the shaft section, wherein the main nut locks the threaded section, and the pivot section is provided for the mounting of the connecting seat.

4. The identifying horizontal lifeline device, as recited in claim 3, wherein the bolt hole has an upper concave cavity with a first expanded diameter connected to the upper end thereof, for providing an upper pad configuration, the upper pad having an upper hole for the shaft section to pass through, and the top surface of the upper pad protruding from the top end of the machine body and abutting against the bottom surface of the identification member,
wherein the bolt hole has a lower concave cavity with a second expanded diameter connected to the lower end thereof, for providing a lower pad configuration, the lower pad has a lower hole for the shaft section to pass through, so that the spring piece is clamped between the cap head and the bottom surface of the lower pad.

5. The identifying horizontal lifeline device, as recited in claim 3, wherein a cross-section of the bolt hole is square, the shaft section is necked in the middle section and is processed to have a square middle bolt that matches the bolt hole, and the middle bolt is further controlled to have a margin for axial movement along the bolt hole.

6. The identifying horizontal lifeline device, as recited in claim 4, wherein a cross-section of the bolt hole is square, the shaft section is necked in the middle section and is processed to have a square middle bolt that matches the bolt hole, and the middle bolt is further controlled to have a margin for axial movement along the bolt hole.

7. The identifying horizontal lifeline device, as recited in claim 3, wherein the pivot section has a slot arranged thereof for the connecting seat to be inserted into, and a rivet hole extending radially therethrough, the rivet hole being adapted to installing a rivet that engages a connecting hole pre-arranged in the connecting seat, thereby allowing the connecting seat to swing with the rivet as a pivot.

8. The identifying horizontal lifeline device, as recited in claim 4, wherein the pivot section has a slot arranged thereof for the connecting seat to be inserted into, and a rivet hole extending radially therethrough, the rivet hole being adapted to installing a rivet that engages a connecting hole pre-arranged in the connecting seat, thereby allowing the connecting seat to swing with the rivet as a pivot.

9. The identifying horizontal lifeline device, as recited in claim 1, wherein the identification member and the machine body are provided with a reminder structure for reminding that the tension is appropriate.

10. The identifying horizontal lifeline device, as recited in claim 2, wherein the identification member and the machine body are provided with a reminder structure for reminding that the tension is appropriate.

11. The identifying horizontal lifeline device, as recited in claim 3, wherein the identification member and the machine body are provided with a reminder structure for reminding that the tension is appropriate.

12. The identifying horizontal lifeline device, as recited in claim 4, wherein the identification member and the machine body are provided with a reminder structure for reminding that the tension is appropriate.

13. The identifying horizontal lifeline device, as recited in claim 9, wherein the reminder structure is composed of a plurality of female nodes provided on the machine body with the bolt hole as the center, and male nodes matching the female nodes provided on the identification member.

14. The identifying horizontal lifeline device, as recited in claim 10, wherein the reminder structure is composed of a plurality of female nodes provided on the machine body with the bolt hole as the center, and male nodes matching the female nodes provided on the identification member.

15. The identifying horizontal lifeline device, as recited in claim 11, wherein the reminder structure is composed of a plurality of female nodes provided on the machine body with the bolt hole as the center, and male nodes matching the female nodes provided on the identification member.

16. The identifying horizontal lifeline device, as recited in claim 12, wherein the reminder structure is composed of a plurality of female nodes provided on the machine body with the bolt hole as the center, and male nodes matching the female nodes provided on the identification member.

17. The identifying horizontal lifeline device, as recited in claim 1, wherein the machine body has a pivot hole and a rotary hole coaxially extending through the front and rear of the chamber, wherein the cable reel is coupled to an axially movable support shaft at the pivot hole and the rotary hole, wherein a sub-gear, a ratchet, and a spring are mounted on the support shaft, enabling the sub-gear to switch between a first position engaging the main gear and a second position disengaged from the main gear, wherein the spring urges the sub-gear to always be positioned toward the first position, wherein the rear end of the support shaft protrudes from the pivot hole and is radially penetrated by a shaft rod for coupling to a handle that capable of being unfolded or retracted, when the handle is unfolded, the handle drives the sub-gear to rotate so as to drive the main gear to adjust the tension, wherein a cam is provided at the portion where the handle is coupled to the shaft rod, so that when the handle is retracted upwardly into the machine body with the shaft rod as a fulcrum, the cam links the support shaft to overcome the spring, thereby placing the sub-gear in a second position disengaged from the main gear, wherein a ratchet block is also mounted within the chamber, one end of the ratchet block is pivotally connected with the machine body via a pin, wherein the other end of the ratchet block is provided with a pawl and a torsion spring is installed, one end of the torsion spring abuts the machine body, and the other end is linked to the ratchet block, enabling the pawl to engage the ratchet regardless of the first position or the second position, preventing the sub-gear from rotating in the first position to pull out the cable.

18. The identifying horizontal lifeline device, as recited in claim 2, wherein the machine body has a pivot hole and a rotary hole coaxially extending through the front and rear of the chamber, wherein the cable reel is coupled to an axially movable support shaft at the pivot hole and the rotary hole, wherein a sub-gear, a ratchet, and a spring are mounted on the support shaft, enabling the sub-gear to switch between a first position engaging the main gear and a second position disengaged from the main gear, wherein the spring urges the sub-gear to always be positioned toward the first position, wherein the rear end of the support shaft protrudes from the pivot hole and is radially penetrated by a shaft rod for coupling to a handle that capable of being unfolded or retracted, when the handle is unfolded, the handle drives the sub-gear to rotate so as to drive the main gear to adjust the tension, wherein a cam is provided at the portion where the handle is coupled to the shaft rod, so that when the handle is retracted upwardly into the machine body with the shaft rod as a fulcrum, the cam links the support shaft to overcome the spring, thereby placing the sub-gear in a second position disengaged from the main gear, wherein a ratchet block is also mounted within the chamber, one end of the ratchet block is pivotally connected with the machine body via a pin, wherein the other end of the ratchet block is provided with a pawl and a torsion spring is installed, one end of the torsion spring abuts the machine body, and the other end is linked to the ratchet block, enabling the pawl to engage the ratchet regardless of the first position or the second position, preventing the sub-gear from rotating in the first position to pull out the cable.

19. The identifying horizontal lifeline device, as recited in claim 3, wherein the machine body has a pivot hole and a rotary hole coaxially extending through the front and rear of the chamber, wherein the cable reel is coupled to an axially movable support shaft at the pivot hole and the rotary hole, wherein a sub-gear, a ratchet, and a spring are mounted on the support shaft, enabling the sub-gear to switch between a first position engaging the main gear and a second position disengaged from the main gear, wherein the spring urges the sub-gear to always be positioned toward the first position, wherein the rear end of the support shaft protrudes from the pivot hole and is radially penetrated by a shaft rod for coupling to a handle that capable of being unfolded or retracted, when the handle is unfolded, the handle drives the sub-gear to rotate so as to drive the main gear to adjust the tension, wherein a cam is provided at the portion where the handle is coupled to the shaft rod, so that when the handle is retracted upwardly into the machine body with the shaft rod as a fulcrum, the cam links the support shaft to overcome the spring, thereby placing the sub-gear in a second position disengaged from the main gear, wherein a ratchet block is also mounted within the chamber, one end of the ratchet block is pivotally connected with the machine body via a pin, wherein the other end of the ratchet block is provided with a pawl and a torsion spring is installed, one end of the torsion spring abuts the machine body, and the other end is linked to the ratchet block, enabling the pawl to engage the ratchet regardless of the first position or the second position, preventing the sub-gear from rotating in the first position to pull out the cable.

20. The identifying horizontal lifeline device, as recited in claim 4, wherein the machine body has a pivot hole and a rotary hole coaxially extending through the front and rear of the chamber, wherein the cable reel is coupled to an axially movable support shaft at the pivot hole and the rotary hole, wherein a sub-gear, a ratchet, and a spring are mounted on the support shaft, enabling the sub-gear to switch between a first position engaging the main gear and a second position disengaged from the main gear, wherein the spring urges the sub-gear to always be positioned toward the first position, wherein the rear end of the support shaft protrudes from the pivot hole and is radially penetrated by a shaft rod for coupling to a handle that capable of being unfolded or retracted, when the handle is unfolded, the handle drives the sub-gear to rotate so as to drive the main gear to adjust the tension, wherein a cam is provided at the portion where the handle is coupled to the shaft rod, so that when the handle is retracted upwardly into the machine body with the shaft rod as a fulcrum, the cam links the support shaft to overcome the spring, thereby placing the sub-gear in a second position disengaged from the main gear, wherein a ratchet block is also mounted within the chamber, one end of the ratchet block is pivotally connected with the machine body via a pin, wherein the other end of the ratchet block is provided with a pawl and a torsion spring is installed, one end of the torsion spring abuts the machine body, and the other end is linked to the ratchet block, enabling the pawl to engage the ratchet regardless of the first position or the second position, preventing the sub-gear from rotating in the first position to pull out the cable.
